(19) United States
(12) Patent Application Publication
(10) Pub. No.: US 2026/0278033 A1
(43) Pub. Date: Sep. 17, 2026

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventor: Yusuke FUJIMOTO, Kanagawa (JP)

(21) Appl. No.: 19/681,107

(22) Filed: May 19, 2026

Related U.S. Application Data
(63) Continuation of application No. PCT/JP2024/036347, filed on Oct. 10, 2024.

(30) Foreign Application Priority Data
Dec. 12, 2023 (JP) 2023-209554

(51) Int. Cl. G06F 17/11

(52) U.S. Cl. CPC G06F 17/11

(57) ABSTRACT

An information processing apparatus extracts, from a first directed acyclic graph in which element information related to an element constituting an optimization problem to be solved corresponds to a node and an order relationship between the elements corresponds to an edge, an execution-required node group including nodes satisfying a condition corresponding to an execution priority of the element, and generates a second directed acyclic graph in which a node group other than the execution-required node group is removed from the first directed acyclic graph, based on the extracted execution-required node group.

### CROSS-REFERENCE TO RELATED APPLICATIONS

This application is a continuation application of International Application No. PCT/JP2024/036347, filed Oct. 10, 2024, the disclosure of which is incorporated herein by reference in its entirety. Further, this application claims priority from Japanese Patent Application No. 2023-209554, filed Dec. 12, 2023, the disclosure of which is incorporated herein by reference in its entirety.

### BACKGROUND

### 1. Technical Field

The present disclosure relates to an information processing apparatus, an information processing method, and an information processing program.

### 2. Description of the Related Art

JP2022-145506A discloses a technique of formulating an operation plan of a vehicle by treating formulation of the operation plan as an optimization problem and obtaining a solution to the optimization problem using a directed graph.

### SUMMARY

In a case where a solution to an optimization problem is obtained using a directed graph, as the number of variables and constraint conditions defining the optimization problem increases, the number of nodes of the directed graph increases, a connection relationship between the nodes is also complicated, and a computational complexity may increase. The technique disclosed in JP2022-145506A is for formulating a replan in a case where there is a change in the operation plan of the vehicle, and does not consider a computational complexity in a case where a solution to an optimization problem is obtained using a directed graph.

The present disclosure has been made in view of the above circumstances, and an object of the present disclosure is to provide an information processing apparatus, an information processing method, and an information processing program capable of reducing a computational complexity in a case where a solution to an optimization problem is obtained using a directed graph.

According to a first aspect, there is provided an information processing apparatus comprising at least one processor, in which the processor is configured to: acquire a first directed acyclic graph in which element information related to an element constituting an optimization problem to be solved corresponds to a node and an order relationship between the elements corresponds to an edge; extract an execution-required node group including nodes satisfying a condition corresponding to an execution priority of the element, from the first directed acyclic graph; and generate a second directed acyclic graph in which a node group other than the execution-required node group is removed from the first directed acyclic graph, based on the extracted execution-required node group.

According to a second aspect, in the information processing apparatus according to the first aspect, the processor is configured to generate the second directed acyclic graph in which the node and the edge that are not related to the execution-required node group are removed from the first directed acyclic graph by filtering the first directed acyclic graph with the execution-required node group.

According to a third aspect, in the information processing apparatus according to the first aspect or the second aspect, the element includes work performed by a worker, and the execution-required node group includes nodes satisfying a condition that an initial inventory of a work object is less than a threshold value.

According to a fourth aspect, in the information processing apparatus according to any one of the first to third aspects, the element includes work performed by a worker, and the execution-required node group includes nodes satisfying a condition that the work is required to be performed at a specific time period.

According to a fifth aspect, in the information processing apparatus according to any one of the first to fourth aspects, the element includes work performed by a worker, and the execution-required node group includes nodes satisfying a condition that the work is required to be performed within a predetermined period after completion of a previous work.

According to a sixth aspect, in the information processing apparatus according to any one of the first to fifth aspects, the element includes work performed by a worker, and the execution-required node group includes nodes satisfying a condition that the work is work on a work object for which a delivery date is set.

According to a seventh aspect, in the information processing apparatus according to any one of the first to sixth aspects, the processor is configured to perform control of displaying a difference between the first directed acyclic graph and the second directed acyclic graph in a display mode in which the difference is identifiable.

According to an eighth aspect, in the information processing apparatus according to any one of the first to seventh aspects, the processor is configured to perform control of displaying the first directed acyclic graph and information indicating that no removable node exists in the first directed acyclic graph in a case where a node group constituting the first directed acyclic graph and the execution-required node group match each other.

According to a ninth aspect, in the information processing apparatus according to any one of the first to eighth aspects, the processor is configured to: extract, from the generated second directed acyclic graph, a subgraph that is aggregatable without adding variables defining the element information or constraint conditions constituting the optimization problem and that includes at least one edge and two or more nodes connected by the edge; and generate a third directed acyclic graph in which the subgraph in the second directed acyclic graph is replaced with a node obtained by aggregating the subgraph.

According to a tenth aspect, there is provided an information processing method executed by a processor provided in an information processing apparatus, the method including: acquiring a first directed acyclic graph in which element information related to an element constituting an optimization problem to be solved corresponds to a node and an order relationship between the elements corresponds to an edge; extracting an execution-required node group including nodes satisfying a condition corresponding to an execution priority of the element, from the first directed acyclic graph; and generating a second directed acyclic graph in which a node group other than the execution-required node group is removed from the first directed acyclic graph, based on the extracted execution-required node group.

According to an eleventh aspect, there is an information processing program causing a processor provided in an information processing apparatus to execute a process including: acquiring a first directed acyclic graph in which element information related to an element constituting an optimization problem to be solved corresponds to a node and an order relationship between the elements corresponds to an edge; extracting an execution-required node group including nodes satisfying a condition corresponding to an execution priority of the element, from the first directed acyclic graph; and generating a second directed acyclic graph in which a node group other than the execution-required node group is removed from the first directed acyclic graph, based on the extracted execution-required node group.

According to the present disclosure, it is possible to reduce a computational complexity in a case of obtaining a solution of an optimization problem using a directed graph.

### BRIEF DESCRIPTION OF THE DRAWINGS

FIG. 1 is a block diagram showing an example of a hardware configuration of an information processing apparatus according to each embodiment.

FIG. 2 is a diagram showing an example of product type data.

FIG. 3 is a diagram showing an example of work shift data of a worker.

FIG. 4 is a diagram showing an example of data related to a skill of the worker.

FIG. 5 is a diagram showing an example of a correspondence relationship between a task and a combination of a product type and a work.

FIG. 6 is a diagram showing an example of a first directed acyclic graph according to a first embodiment.

FIG. 7 is a block diagram showing an example of a functional configuration of an information processing apparatus according to the first embodiment.

FIG. 8 is a diagram showing an example of an aggregatable subgraph.

FIG. 9 is a diagram showing an example of data related to the skill of the worker after update.

FIG. 10 is a diagram showing an example of a second directed acyclic graph according to the first embodiment.

FIG. 11 is a diagram showing an example of a directed acyclic graph display screen according to the first embodiment.

FIG. 12 is a diagram showing an example of a directed acyclic graph display screen according to a modification example.

FIG. 13 is a flowchart showing an example of node aggregation processing.

FIG. 14 is a diagram showing an example of delivery date data.

FIG. 15 is a diagram showing an example of performable work data.

FIG. 16 is a diagram showing an example of production capacity data.

FIG. 17 is a diagram showing an example of fixed plan data.

FIG. 18 is a diagram showing an example of initial inventory data.

FIG. 19 is a diagram showing an example of time constraint data.

FIG. 20 is a diagram showing an example of a first directed acyclic graph according to a second embodiment.

FIG. 21 is a block diagram showing an example of a functional configuration of an information processing apparatus according to the second embodiment.

FIG. 22 is a diagram showing an example of a second directed acyclic graph according to the second embodiment.

FIG. 23 is a diagram showing an example of a directed acyclic graph display screen according to the second embodiment.

FIG. 24 is a diagram showing an example of a directed acyclic graph display screen according to a modification example.

FIG. 25 is a flowchart showing an example of node removal processing.

### DETAILED DESCRIPTION

Hereinafter, examples of embodiments for implementing the technology of the present disclosure will be described in detail with reference to the drawings.

### First Embodiment

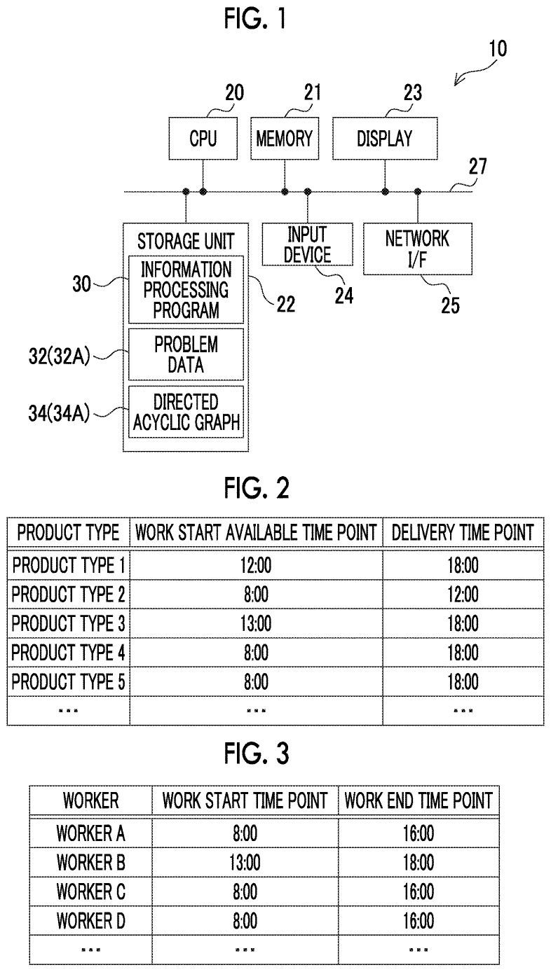

In the first embodiment, an example in which a job shop scheduling problem is applied as an optimization problem to be solved will be described. A hardware configuration of an information processing apparatus 10 according to the first embodiment will be described with reference to FIG. 1. Examples of the information processing apparatus 10 include computers such as a personal computer or a server computer. As shown in FIG. 1, the information processing apparatus 10 includes a central processing unit (CPU) 20, a memory 21 as a temporary storage area, and a non-volatile storage unit 22. The information processing apparatus 10 also includes a display 23 such as a liquid crystal display, an input device 24 such as a keyboard and a mouse, and a network interface (I/F) 25 connected to a network. The CPU 20, the memory 21, the storage unit 22, the display 23, the input device 24, and the network I/F 25 are connected to a bus 27. The CPU 20 is an example of a processor according to the disclosed technology.

The storage unit 22 is realized by a hard disk drive (HDD), a solid state drive (SSD), a flash memory, or the like. An information processing program 30 is stored in the storage unit 22 as a storage medium. The CPU 20 reads out the information processing program 30 from the storage unit 22, loads the read information processing program 30 in the memory 21, and executes the loaded information processing program 30.

The storage unit 22 stores problem data 32 in which an optimization problem to be solved by the information processing apparatus 10 is represented in a format processable by the information processing apparatus 10. The problem data 32 includes element information that is information related to an element constituting the optimization problem to be solved, constraint conditions, and the like. The element constituting the optimization problem to be solved includes work performed by a worker on a work object. The term “work object” further refers to a workpiece or a target product.

The problem data 32 according to the first embodiment includes product type data shown in FIG. 2. As shown in FIG. 2, in the product type data, a earliest start time for a product type and a delivery time point of the product type are associated with each other for each product type that is a work object by a worker.

In addition, the problem data 32 includes work shift data of a worker shown in FIG. 3. As shown in FIG. 3, in the work shift data of the worker, a work start time point and a work end time point of the worker are associated with each worker.

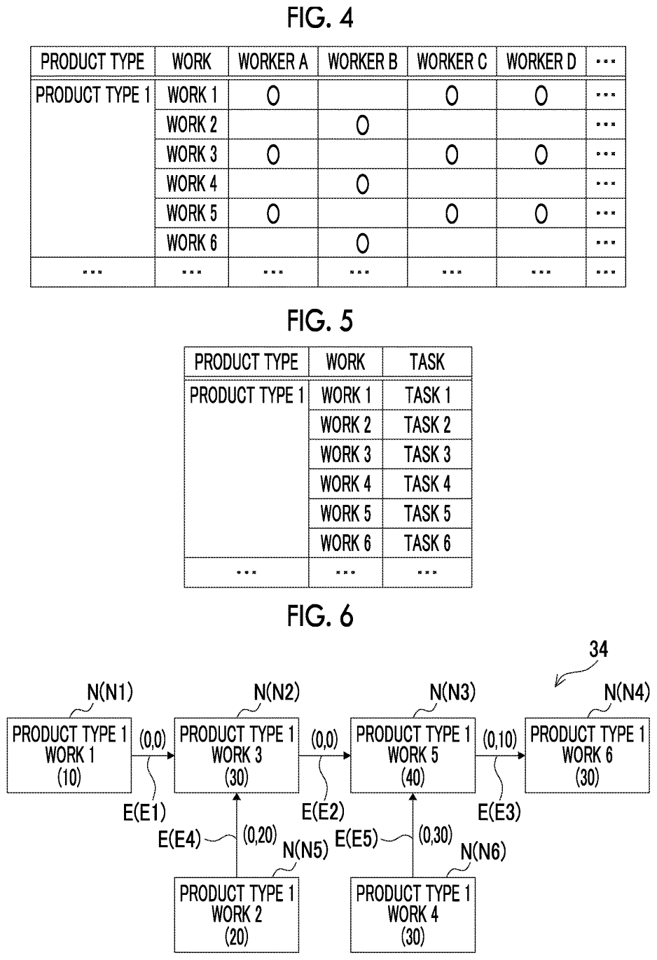

In addition, the problem data 32 includes data related to a skill of a worker shown in FIG. 4. As shown in FIG. 4, in the data related to the skill of the worker, information indicating whether each worker can perform work on a product type is associated with each combination of the product type and the work. In the example of FIG. 4, a field marked with a circle indicates that the worker can perform the work on the product type, and an empty field indicates that the worker cannot perform the work on the product type. In the example of FIG. 4, the worker A can perform work 1, work 3, and work 5 on product type 1, and cannot perform work 2, work 4, and work 6 on product type 1.

In addition, as shown in FIG. 5, in the problem data 32, a combination of the product type and the work is treated as a task. The example in FIG. 5 indicates that a combination of product type 1 and work 1 is task 1.

In addition, the problem data 32 includes work sequence data. The work sequence data includes work required for manufacturing the product type, a constraint on a work sequence, a required time for the work, a waiting time between the works, and the like for each product type.

In the first embodiment, the above data is expressed by variables shown below.
i∈T={task 1, task 2, . . . }: set of tasks
pᵢ: required time of task i

$${s}_{i}^{startble} :$$

work start available time point of task i

$${e}_{i}^{deadline} :$$

delivery time point of task i
w∈W4={worker A, worker B, . . . }: set of workers

$${s}_{w}^{shift} :$$

work start time point of worker

$${e}_{w}^{shift} :$$

work end time point of worker
(i,j)∈T^{precedence}: pair of tasks subject to precedence constraint

$${p}_{i , j}^{span - lb} ( ∀ i , j ∈ {T}^{precedence - lb} ) :$$

minimum waiting time between task i and task j

$${p}_{i , j}^{span - ub} ( ∀ i , j ∈ {T}^{precedence - ub} ) :$$

minimum waiting time between task i and task j
q_{i,w}: whether worker w can perform task i (0: impossible, 1: possible)

In addition, the problem data 32 includes constraint conditions represented by the following Expressions (1) to (8). Expression (1) indicates a condition that each task starts after the earliest start time. Expression (2) indicates a condition that each task is completed by a delivery date. Expression (3) indicates a condition that the work start time point of the worker is satisfied. Expression (4) indicates a condition that the work end time point of the worker is satisfied. Expression (5) indicates a condition that each task is assigned to one worker. Expression (6) indicates a condition that only one task is assigned to each worker at the same time. Expression (7) represents a condition that the precedence constraint and the waiting time between tasks are satisfied. Expression (8) indicates a condition that each task is assigned to only a worker who can perform the task.

$$\begin{matrix}{s}_{i}^{startble} \leq {s}_{i} , & ∀ i ∈ T\end{matrix} \qquad ( 1 )$$

$$\begin{matrix}{s}_{i} + {p}_{i} \leq {e}_{i}^{deadline} , & ∀ i ∈ T\end{matrix} \qquad ( 2 )$$

$$\begin{matrix}{s}_{w}^{shift} \cdot {a}_{i , w} \leq {s}_{i} , & ∀ i ∈ T , w ∈ W\end{matrix} \qquad ( 3 )$$

$$\begin{matrix}{s}_{i} + {a}_{i , w} \cdot {p}_{i} \leq {e}_{w}^{shift} , & ∀ i ∈ T , w ∈ W\end{matrix} \qquad ( 4 )$$

$$\begin{matrix}{\sum }_{w} {a}_{i , w} = 1 , & ∀ i ∈ T\end{matrix} \qquad ( 5 )$$

$$\begin{matrix}\begin{matrix}{e}_{i} \leq {s}_{j} + M ( 3 - {a}_{i , w} - {a}_{j , w} - {o}_{i , j , w} ) \\ {e}_{j} \leq {s}_{i} + M ( 2 - {a}_{i , w} - {a}_{j , w} - {o}_{i , j , w} )\end{matrix} \} \\ \text{?} M is a sufficiently large constant \\ \text{?} o is a binary variable used in the formulation\end{matrix} \qquad ( 6 )$$

$$\begin{matrix}{s}_{i} + {p}_{i} + {p}_{i , j}^{span - lb} \leq {s}_{j} , & ∀ ( i , j ) ∈ {T}^{predecence - lb} \\ {s}_{i} + {p}_{i} + {p}_{i , j}^{span - u b} \geq {s}_{j} , & ∀ ( i , j ) ∈ {T}^{predecence - u b}\end{matrix} \} \qquad ( 7 )$$

$$\begin{matrix}{a}_{i , w} = 0 & ∀ ( i , j ) ∈ \{ i , w \vert\end{matrix} i ∈ T , w ∈ W , {q}_{i , w} = 0 \} \qquad ( 8 )$$

In addition, the problem data 32 includes an objective function. The objective function is set to complete the task to be completed last as early as possible and is indicated by Expressions (9) and (10).

$$min \{ C \} \qquad ( 9 )$$

$$\begin{matrix}{s}_{i} + {p}_{i} \leq C , & ∀ i ∈ T\end{matrix} \qquad ( 10 )$$

In addition, the problem data 32 includes a decision variable. The decision variable is a variable representing, for example, a start time point of task i and whether or not task i is assigned to worker w.

In addition, the storage unit 22 stores a directed acyclic graph 34. The directed acyclic graph 34 is generated based on the problem data 32 and is stored in the storage unit 22 in advance. FIG. 6 shows an example of the directed acyclic graph 34. As shown in FIG. 6, the directed acyclic graph 34 includes a plurality of nodes N and edges E connecting the nodes N. In a case where the nodes N are distinguished from each other, a number is added to an end of a reference numeral. In addition, in a case where the edges E are distinguished from each other, a number is added to an end of a reference numeral.

Work information related to work as an example of an element constituting the optimization problem to be solved corresponds to the node N. In the first embodiment, a product type of a work target, work performed by a worker, and a required time for the work correspond to the node N. In the example of FIG. 6, the product type is described in an upper part of the node N, the work is described in a middle part, and the required time is described in parentheses in a lower part. For example, the node N1 represents that the required time for the work 1 for the product type 1 is 10 minutes.

In addition, an order relationship between the pieces of work corresponding to the two nodes N corresponds to the edge E. In addition, in the first embodiment, a minimum waiting time and a maximum waiting time between the works are also defined by the edge E. In the example of FIG. 6, a direction of an arrow represents the order relationship between the works. In addition, in the example of FIG. 6, among two numbers in parentheses in the vicinity of the arrow, a left side represents the minimum waiting time, and a right side represents the maximum waiting time. Only one of the minimum waiting time and the maximum waiting time may be defined by the edge E.

For example, the work 3 for the product type 1 of the node N2 indicates that it can be performed in a case where both the work 1 for the product type 1 of the node N1 and the work 2 for the product type 1 of the node N5 are completed. Further, the work 3 for the product type 1 of the node N2 indicates that the work is performed without any waiting time after completion of the work 1 for the product type 1 of the node N1, and is performed within 20 minutes from completion of the work 2 for the product type 1 of the node N5, that is, at 0 minutes or more and 20 minutes or less from that completion time.

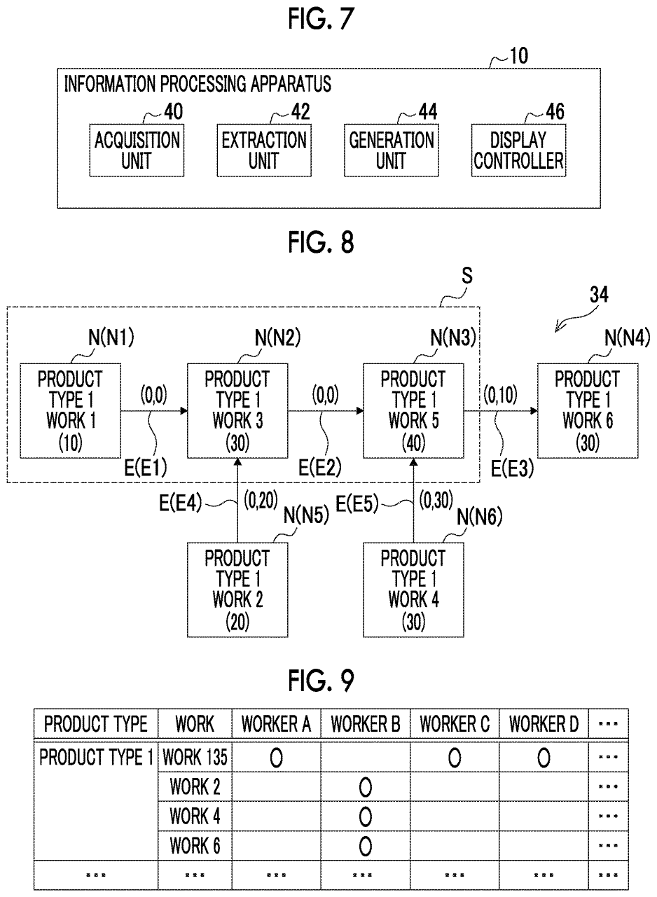

Next, a functional configuration of the information processing apparatus 10 according to the first embodiment will be described with reference to FIG. 7. As shown in FIG. 7, the information processing apparatus 10 includes an acquisition unit 40, an extraction unit 42, a generation unit 44, and a display controller 46. The CPU 20 executes the information processing program 30 to function as the acquisition unit 40, the extraction unit 42, the generation unit 44, and the display controller 46.

The acquisition unit 40 acquires the directed acyclic graph 34 from the storage unit 22. The extraction unit 42 extracts a subgraph S (see FIG. 8) that is aggregatable without adding the variables defining the work information or the constraint conditions constituting the optimization problem from the directed acyclic graph 34 acquired by the acquisition unit 40, the subgraph S including at least one edge E and two or more nodes N connected by the edge E.

Specifically, the extraction unit 42 extracts the aggregatable subgraph S from the directed acyclic graph 34 based on at least one of the work to be executed, the order of the work, the required time for the work, the skill of the worker indicating whether the worker can perform the work, or the work shift of the worker.

More specifically, the extraction unit 42 extracts the subgraph S satisfying all of the following conditions (1) to (3) from the directed acyclic graph 34.
(1) The subgraph S is configured to include a group of nodes N corresponding to a group of works that are required to be performed continuously. The group of works that are required to be performed continuously referred to here means a group of works that are consecutive sequential works and in which the minimum waiting time and the maximum waiting time between the works are zero.
(2) There is a worker who can perform all pieces of work corresponding to the group of nodes N constituting the subgraph S, and there is no worker who can perform only a part of all pieces of work.
(3) In a case where there are a plurality of workers who can perform all pieces of work corresponding to the group of nodes N constituting the subgraph S, the work shifts of the plurality of workers are the same.

FIG. 8 shows an example of the subgraph S extracted from the directed acyclic graph 34 shown in FIG. 6. As shown in FIG. 8, in this example, the extraction unit 42 extracts the subgraph S composed of three nodes N1, N2, and N3 and two edges E1 and E2 connecting the three nodes N.

The node N1 and the node N2 correspond to works that are required to be performed continuously, and the minimum waiting time and the maximum waiting time defined by the edge E1 are zero. Similarly, the node N2 and the node N3 correspond to works that are required to be performed continuously, and the minimum waiting time and the maximum waiting time defined by the edge E2 are zero. That is, in the example of FIG. 8, the subgraph S satisfies the condition of (1).

In addition, there are workers A, C, and D who are workers capable of performing all the works 1, 3, and 5 for the product type 1 corresponding to the nodes N1, N2, and N3, and there is no worker who can perform only a part of the works 1, 3, and 5 for the product type 1 (see FIG. 4). That is, in the example of FIG. 8, the subgraph S satisfies the condition of (2).

In addition, there are a plurality of workers A, C, and D who are workers capable of performing all the works 1, 3, and 5 for the product type 1 corresponding to the nodes N1, N2, and N3, and the work shifts of the workers A, C, and D are the same (see FIG. 3). That is, in the example of FIG. 8, the subgraph S satisfies the condition of (3).

The extraction unit 42 may extract the subgraph S satisfying one or two conditions of (1) to (3) from the directed acyclic graph 34. In addition, the extraction unit 42 may update the problem data 32 in a case of extracting the subgraph S. For example, the extraction unit 42 may update the data related to the skill of the worker shown in FIG. 4 as shown in FIG. 9. As shown in FIG. 9, in this case, the three works 1, 3, and 5 for the product type 1 are updated to one aggregated work.

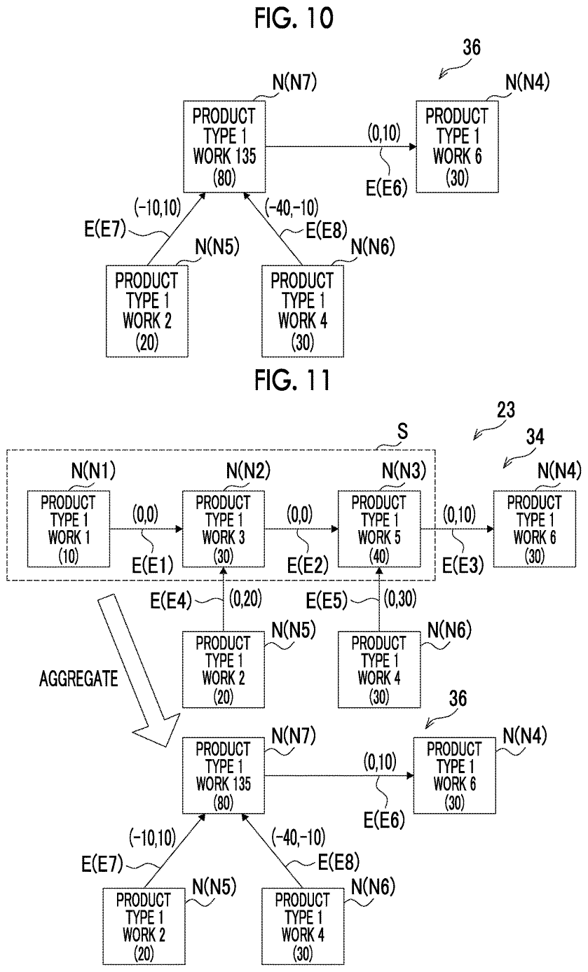

The generation unit 44 generates a directed acyclic graph 36 in which the subgraph S extracted by the extraction unit 42 in the directed acyclic graph 34 is replaced with the node N obtained by aggregating the subgraph S. FIG. 10 shows an example of the directed acyclic graph 36. FIG. 10 shows an example in which the subgraph S shown in FIG. 8 is aggregated into one node N7. In the node N7, the required time is the sum of the required times of all the nodes N constituting the subgraph S. In addition, the edge E3 connecting the node N3 constituting the subgraph S and the node N4 is replaced with the edge E6 connecting the node N7 and the node N4. In addition, the edge E4 connecting the node N2 constituting the subgraph S and the node N5 is replaced with the edge E7 connecting the node N7 and the node N5. In addition, the edge E5 connecting the node N3 constituting the subgraph S and the node N6 is replaced with the edge E8 connecting the node N7 and the node N6.

The generation unit 44 updates the minimum waiting time and the maximum waiting time for the edge E (in the example of FIG. 10, the edges E7 and E8) directed toward the node N obtained by aggregating the subgraph S, among the edges E, as follows. That is, in this case, the generation unit 44 updates the minimum waiting time and the maximum waiting time by subtracting the required time of the work performed before the node N included in the subgraph S connected by the edge E before the update from the minimum waiting time and the maximum waiting time defined by the edge E before the update.

For example, the edge E5 in FIG. 8 has a minimum waiting time of zero and a maximum waiting time of 30 minutes. The required times of the work of the nodes N1 and N2 performed before the node N3 included in the subgraph S connected by the edge E5 are 10 minutes and 30 minutes. In a case where the respective required times are subtracted from the minimum waiting time and the maximum waiting time defined by the edge E5, the minimum waiting time is −40 minutes, and the maximum waiting time is −10 minutes. The minimum waiting time and the maximum waiting time defined by the edge E8 after the update in the example of FIG. 10 are the times updated in this way.

The display controller 46 performs control of displaying the directed acyclic graph 34 and the directed acyclic graph 36 in a display mode in which a difference therebetween can be identified. For example, as shown in FIG. 11, the display controller 46 performs control of displaying the directed acyclic graph 34 and the directed acyclic graph 36 side by side on the display 23. FIG. 11 shows an example in which the display controller 46 performs control of displaying an arrow from the subgraph S to the node N7 and a character string “aggregation” in addition to the directed acyclic graph 34 and the directed acyclic graph 36. As a result, it is easy for the user to understand the aggregated portion of the directed acyclic graph 34. The display mode is not limited to the example shown in FIG. 11 as long as the difference between the directed acyclic graph 34 and the directed acyclic graph 36 can be identified.

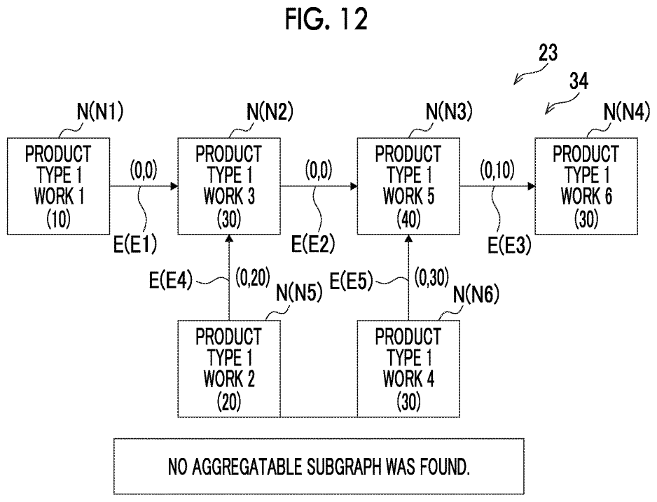

In a case in which the display controller 46 cannot extract the aggregatable subgraph S from the directed acyclic graph 34, the display controller 46 may perform control of displaying information indicating that no aggregatable subgraph S exists in the directed acyclic graph 34. For example, as shown in FIG. 12, the display controller 46 may perform control of displaying the directed acyclic graph 34 and a message indicating that no aggregatable subgraph S exists on the display 23. The case in which the aggregatable subgraph S cannot be extracted from the directed acyclic graph 34 is, for example, a case in which the subgraph S satisfying all of the conditions (1) to (3) is not present in the directed acyclic graph 34.

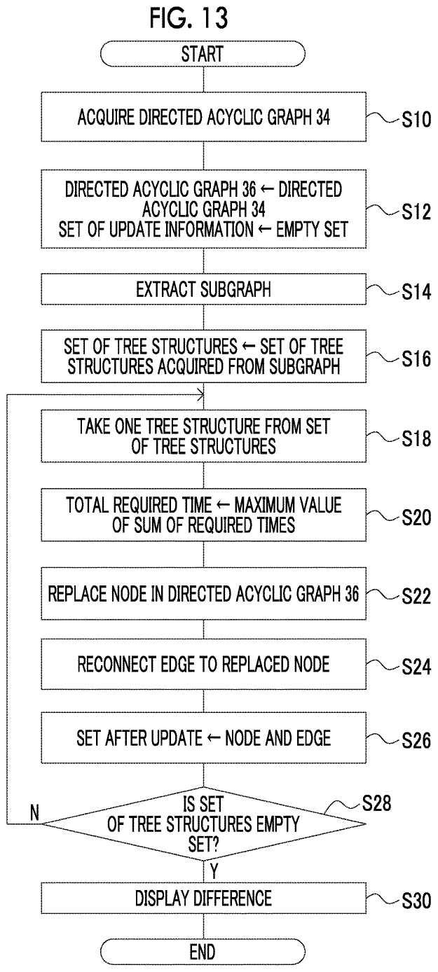

Next, an operation of the information processing apparatus 10 according to the first embodiment will be described with reference to FIG. 13. The CPU 20 executes the information processing program 30 to execute the node aggregation processing shown in FIG. 13. The node aggregation processing is executed, for example, in a case in which an instruction to start the execution is input by the user.

In step S10 of FIG. 13, the acquisition unit 40 acquires the directed acyclic graph 34 from the storage unit 22. In step S12, the generation unit 44 copies the directed acyclic graph 34 to obtain a directed acyclic graph 36, and initializes a set of update information to an empty set. In step S14, the extraction unit 42 extracts the subgraph S from the directed acyclic graph 34 acquired in step S10, as described above.

In step S16, the generation unit 44 assigns the set of tree structures acquired from the subgraph S extracted in step S14 to the set of tree structures used in the processing in step S18 and subsequent steps. In step S18, the generation unit 44 takes one tree structure from the set of tree structures. In step S20, the generation unit 44 specifies a path in which a sum of required times is maximized in the tree structure extracted in step S18, and calculates the sum of the required times of the specified path as a total required time.

In step S22, the generation unit 44 replaces the group of nodes N included in the path specified in step S20 in the directed acyclic graph 36 with one node N in which the calculated total required time is used as the required time. In step S24, the generation unit 44 reconnects the edge E to the node N replaced in step S22. In this case, as described above, the generation unit 44 updates the minimum waiting time and the maximum waiting time of the edge E.

In step S26, the generation unit 44 adds the group of nodes N and the edge E before the replacement in step S24 and one node N after the replacement to the set of update information. In step S28, the generation unit 44 determines whether or not the set of tree structures is an empty set. In a case in which the determination result is No, the process returns to step S18, and in a case in which the determination result is Yes, the process proceeds to step S30.

In step S30, as described above, the display controller 46 performs control of displaying the directed acyclic graph 34 and the directed acyclic graph 36 in a display mode in which a difference therebetween can be identified, based on the set of update information. In a case where the processing of step S30 is ended, the node aggregation processing is ended.

The CPU 20 executes processing for solving the optimization problem using the directed acyclic graph 36 generated as described above. Specifically, the CPU 20 performs search processing using a known search algorithm such as a breadth-first search on the directed acyclic graph 36 to obtain a solution in which the output of the objective function is minimized. As a result, it is possible to assign the optimal worker to the work corresponding to each node N.

As described above, according to the first embodiment, it is possible to reduce the computational complexity in a case of obtaining the solution of the optimization problem by using the directed graph.

The disclosed technology may be applied to an optimization problem that can be expressed by a directed acyclic graph having a structure different from the directed acyclic graph 34 in the example shown in the first embodiment.

### Second Embodiment

A second embodiment of the disclosed technology will be described. It should be noted that the hardware configuration of the information processing apparatus 10 according to the second embodiment is the same as the configuration in the first embodiment, and thus the description thereof will be omitted. In the second embodiment, an example will be described in which planning is applied in which, as the optimization problem to be solved, which product type is to be produced in what quantity in a unit period is determined together with a transition of the inventory quantity, based on the total number of product types to be manufactured within a set period (hereinafter, referred to as a “set period”). It is assumed that inventory is allocated such that, except for the first work, production is performed only in an amount corresponding to the inventory consumed in the previous work. In addition, the inventory is given in advance as an initial inventory on the first day, or is reflected in the inventory on the next day by the amount produced in the work. In the second embodiment, a case where one day is applied as the unit period will be described as an example, but the unit period is not limited to one day. For example, the unit period may be half a day or one week.

As shown in FIG. 1, in the second embodiment, the storage unit 22 stores problem data 32A in which the optimization problem to be solved by the information processing apparatus 10 is represented in a format processable by the information processing apparatus 10. The problem data 32A includes element information that is information related to an element constituting the optimization problem to be solved, constraint conditions, and the like. In the second embodiment, the element constituting the optimization problem to be solved includes work performed by the worker on the work object. The work performed by the worker on the work object means work of producing a product type that is the work object.

The problem data 32A includes the product type that is the work object, a plurality of pieces of work required to be performed, and a work order of the plurality of pieces of work.

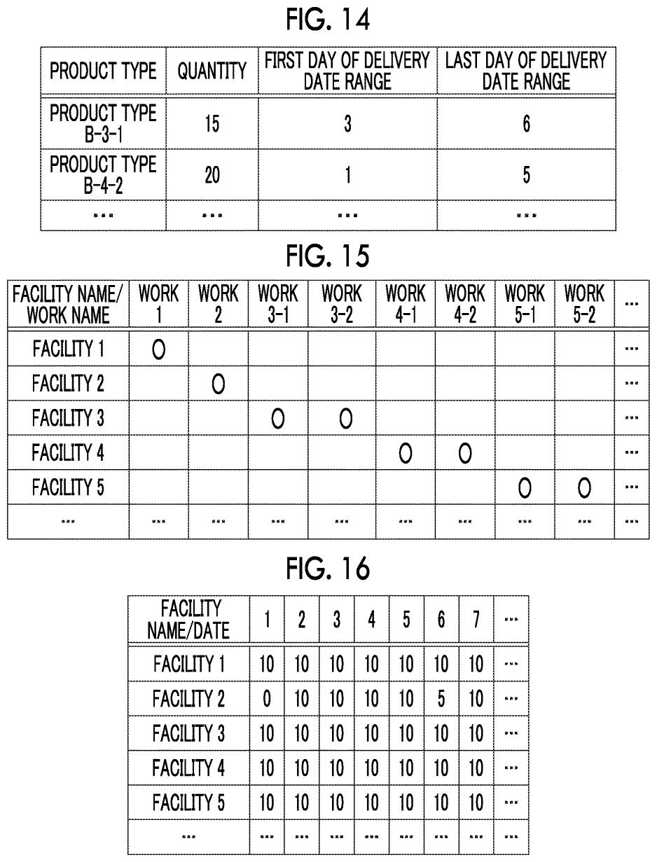

In addition, the problem data 32A includes delivery date data shown in FIG. 14. As shown in FIG. 14, in the delivery date data, the production quantity within the set period and the first day and the last day of the period representing the range of the delivery date are associated with each product type of the product that is the work object by the worker. In the second embodiment, in order to represent that each product type changes a form in each work, a unique name is given to the product type in each work. In addition, the date within the set period is represented by a relative numerical value in which the first day within the set period is set to “1”. In addition, the delivery date can be individually set for a product type other than the product type that is the target of the last work of the day, assuming that there is a demand for a semi-finished product or the like. In the example of FIG. 14, the product type B-3-1 represents that 15 pieces need to be produced between the third day and the sixth day within the set period. In addition, in this case, 15 pieces of the product type B-3-1 are not consumable in the subsequent work. That is, the product type included in the delivery date data is the work object for which the delivery date is set.

In addition, the problem data 32A includes performable work data shown in FIG. 15. As shown in FIG. 15, in the performable work data, information indicating whether or not each work can be performed is associated with each facility. In the example of FIG. 15, a field marked with a circle indicates that the facility is capable of performing the work, and an empty field represents that the facility is incapable of performing the work. In the example of FIG. 15, the facility 1 is capable of performing the work 1 and incapable of performing works other than the work 1.

In addition, the problem data 32A includes production capacity data shown in FIG. 16. As shown in FIG. 16, in the production capacity data, an upper limit value of the number of products of each product type that can be produced by the facility in one day within the set period is associated with each facility. A reason why the values of the facility 2 on the first day and the sixth day in FIG. 16 are smaller than those on other days is, for example, a decrease in production capacity due to maintenance, trial production, or the like.

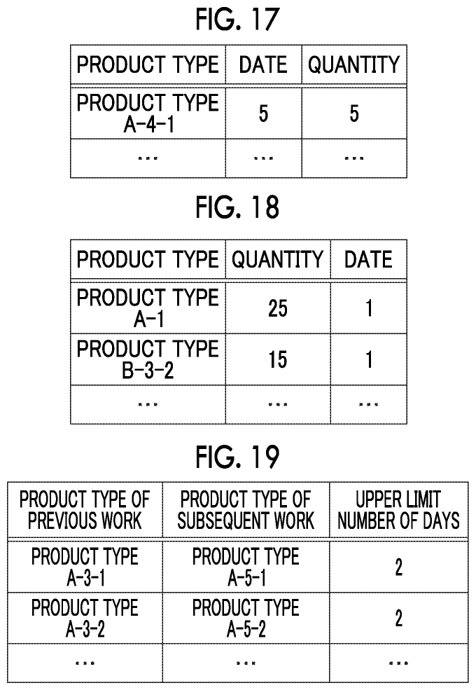

In addition, the problem data 32A includes fixed plan data shown in FIG. 17. As shown in FIG. 17, in the fixed plan data, a date representing a work execution date of a product type for which a date on which the work is performed is fixed, regardless of the delivery date or the like, and the production quantity of the product type on that date are associated with each other. In the example of FIG. 17, the product type A-4-1 represents that five items need to be produced on the fifth day within the set period. That is, the product type included in the fixed plan data is a product type produced by the work performed at a specific time period.

In addition, the problem data 32A includes initial inventory data shown in FIG. 18. As shown in FIG. 18, in the initial inventory data, the quantity of the initial inventory is associated with each product type. In addition, as shown in FIG. 18, “1” is stored in the date column to indicate that the inventory is on the first day within the set period. In the example of FIG. 18, the product type A-1 represents that the initial inventory quantity is 25.

In addition, the problem data 32A includes time constraint data shown in FIG. 19. In the time constraint data, an upper limit value of the number of days from the completion of the previous work to the performance of the subsequent work is associated with each pair of product types. In the example of FIG. 19, the time constraint data represents that the work of producing the product type A-5-1 needs to be performed within two days from the completion time of the work of producing the product type A-3-1. That is, among the pairs of product types included in the problem data 32A, the product type produced by the subsequent work is a product type produced by the work required to be performed within a predetermined period after the completion of the previous work.

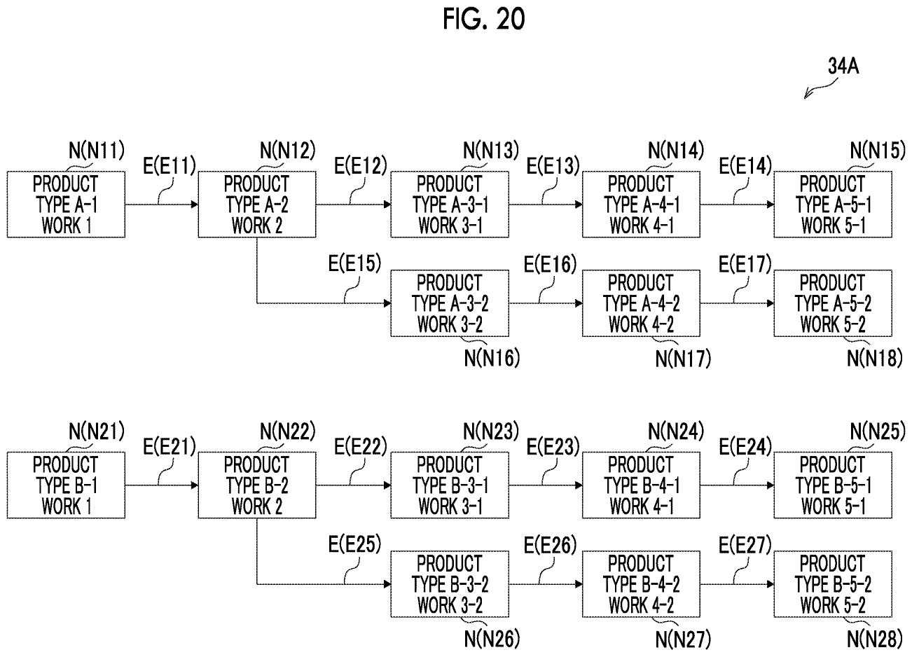

In addition, in the second embodiment, the storage unit 22 stores a directed acyclic graph 34A. The directed acyclic graph 34A is generated based on the problem data 32A and is stored in the storage unit 22 in advance. FIG. 20 shows an example of the directed acyclic graph 34A. As shown in FIG. 20, the directed acyclic graph 34A includes a plurality of nodes N and edges E connecting the nodes. In a case where the nodes N are distinguished from each other, a number is added to an end of a reference numeral. In addition, in a case where the edges E are distinguished from each other, a number is added to an end of a reference numeral.

Work information related to work as an example of an element constituting the optimization problem to be solved corresponds to the node N. In the second embodiment, the product type to be worked on and the work performed by the worker correspond to the node N. In addition, an order relationship between the pieces of work corresponding to the two nodes N corresponds to the edge E. In the example of FIG. 20, after completion of the work 1 of the node N11, the work 2 of the node N12 can be performed. The directed acyclic graph 34A is an example of a first directed acyclic graph according to the disclosed technology.

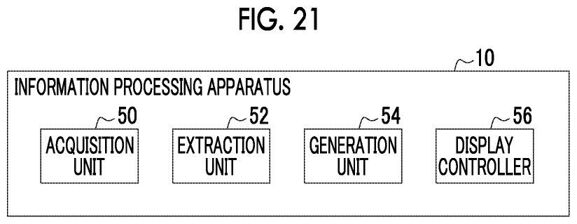

Next, a functional configuration of the information processing apparatus 10 according to the second embodiment will be described with reference to FIG. 21. As shown in FIG. 21, the information processing apparatus 10 includes an acquisition unit 50, an extraction unit 52, a generation unit 54, and a display controller 56. The CPU 20 executes the information processing program 30 to function as the acquisition unit 50, the extraction unit 52, the generation unit 54, and the display controller 56.

The acquisition unit 50 acquires the directed acyclic graph 34A from the storage unit 22. The extraction unit 52 extracts an execution-required node group including the nodes N satisfying the condition corresponding to the execution priority of the work, from the directed acyclic graph 34A acquired by the acquisition unit 50. Specifically, the extraction unit 52 extracts the execution-required node group including the nodes N corresponding to the work satisfying the condition determined as the condition that the execution priority is relatively high among the respective works corresponding to the respective nodes N of the directed acyclic graph 34A, from the directed acyclic graph 34A.

More specifically, the extraction unit 52 extracts the execution-required node group including the nodes N satisfying at least one condition of the following four conditions (A) to (D), from the directed acyclic graph 34A.
(A) The initial inventory of the work object is less than a threshold value.
(B) The work is required to be performed at a specific time period.
(C) The work is required to be performed within a predetermined period after completion of the previous work. The previous work referred to here includes not only the immediately preceding work but also the work further preceding the immediately preceding work in the implementation order.
(D) The work is the work on the work object for which the delivery date is set.

The extraction unit 52 determines whether or not the condition (A) is satisfied based on the initial inventory data (see FIG. 18) described above. In addition, the extraction unit 52 determines whether or not the condition (B) is satisfied based on the fixed plan data (see FIG. 17) described above. In addition, the extraction unit 52 determines whether or not the condition (C) is satisfied based on the time constraint data (see FIG. 19) described above. In addition, the extraction unit 52 determines whether or not the condition (D) is satisfied based on the delivery date data (see FIG. 14) described above.

Further, the extraction unit 52 may add a node group serving as a prerequisite of the node N satisfying the conditions (A) to (D) to the execution-required node group. The node group that is a prerequisite of the node N is a node group to which the tracing reaches in a case where the edge E is traced from the node N in a direction opposite to the direction of the arrow.

The generation unit 54 generates a directed acyclic graph 36A in which the node group other than the execution-required node group is removed from the directed acyclic graph 34A based on the execution-required node group extracted by the extraction unit 52. Specifically, the generation unit 54 generates the directed acyclic graph 36A in which the node N and the edge E not related to the execution-required node group are removed from the directed acyclic graph 34A by filtering the directed acyclic graph 34A with the execution-required node group. The node N not related to the execution-required node group referred to here is a node N that is not a prerequisite of the execution-required node group, and is, for example, a node group to which the tracing does not reach in a case where the edge E is traced from the nodes N of the execution-required node group in a direction opposite to the direction of the arrow. In addition, the edge E not related to the execution-required node group is an edge E connected to the node N not related to the execution-required node group.

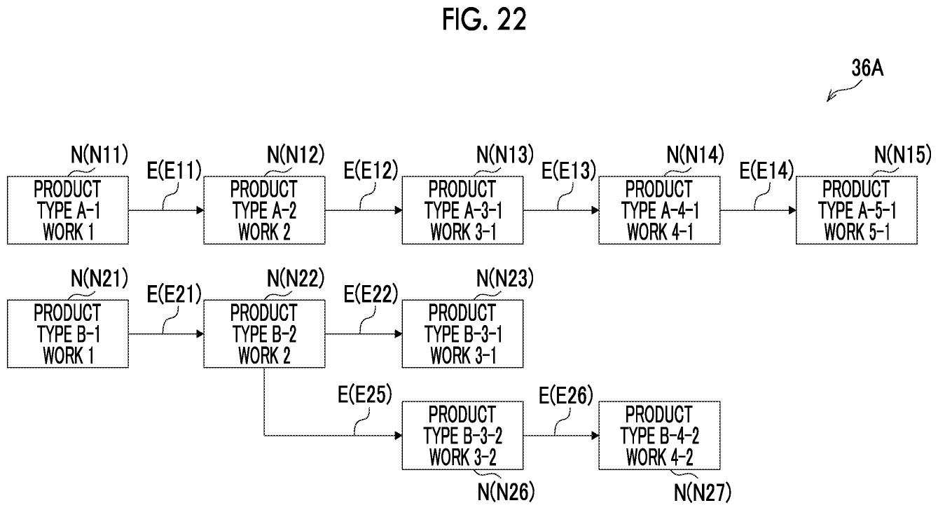

FIG. 22 shows an example of the directed acyclic graph 36A. In the example of FIG. 22, the directed acyclic graph 36A in which the nodes N and the edges E not related to the execution-required node group are removed from the directed acyclic graph 34A shown in FIG. 20 is shown. The directed acyclic graph 36A is an example of a second directed acyclic graph according to the disclosed technology.

For example, in a case where the node N15 is extracted as the execution-required node group by the time constraint data described above, the nodes N11 to N14 are not removed even in a case where the nodes N11 to N14 are not extracted as the execution-required node group because the nodes N11 to N14 are nodes that are a prerequisite of the node N15.

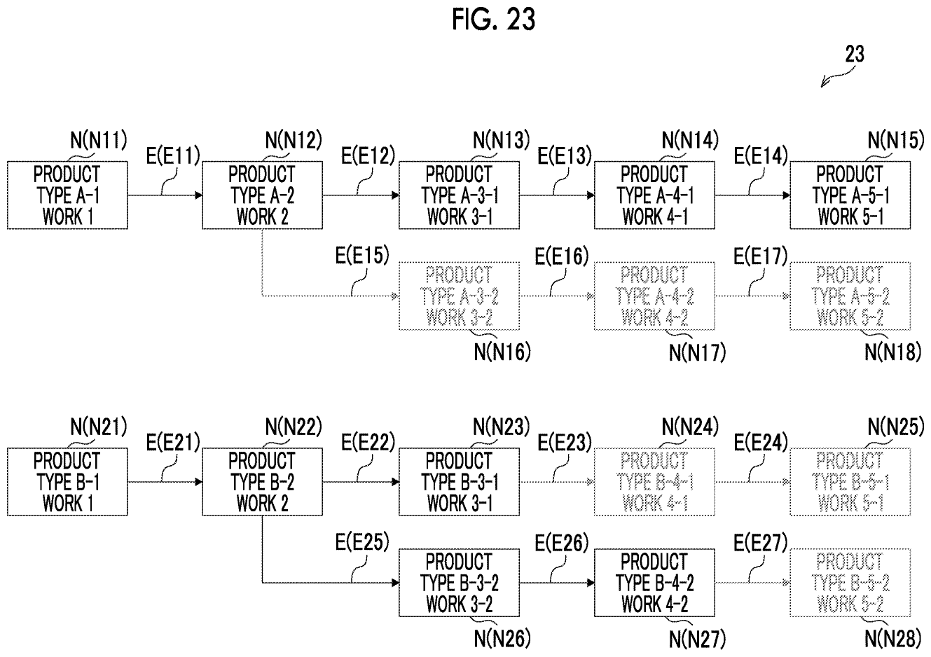

The display controller 56 performs control of displaying the directed acyclic graph 34A and the directed acyclic graph 36A in a display mode in which a difference therebetween can be identified. For example, as shown in FIG. 23, the display controller 56 performs control of displaying, on the display 23, the node N included in the execution-required node group and the edges E directed toward the nodes N included in the execution-required node group in the directed acyclic graph 34A in a preset first color such as black. Further, the display controller 56 performs control of displaying, on the display 23, the node N and the edge E removed in a case where the directed acyclic graph 36A is generated in the directed acyclic graph 34A in a second color (gray in the example of FIG. 23) set as a color that is less noticeable than the first color. Accordingly, it is easy for the user to understand the removed portion of the directed acyclic graph 34A. The display mode is not limited to the example shown in FIG. 23 as long as the difference between the directed acyclic graph 34A and the directed acyclic graph 36A is identifiable.

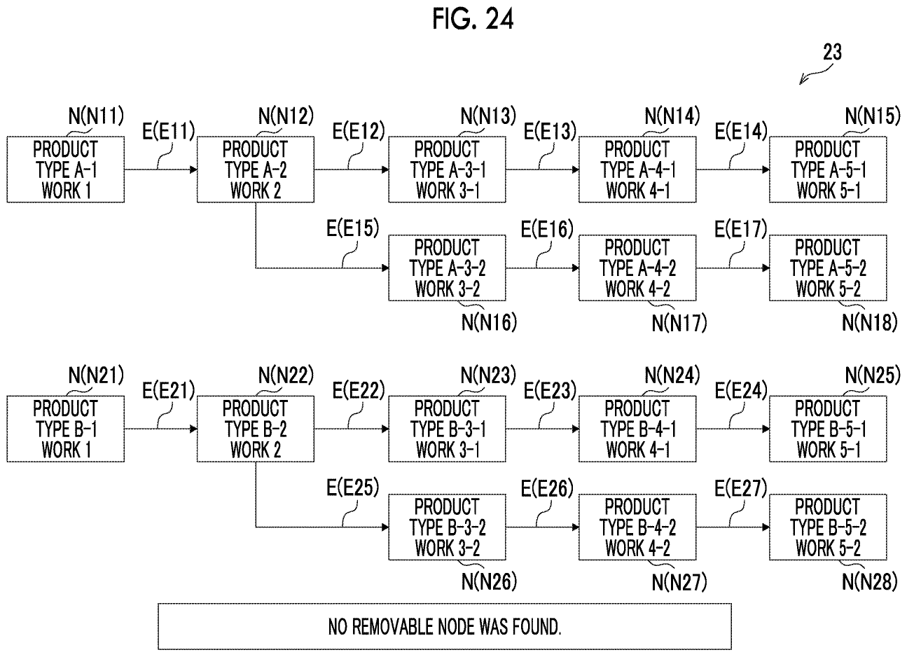

In a case where the node group constituting the directed acyclic graph 34A and the execution-required node group match, the display controller 56 may perform control of displaying the directed acyclic graph 34A and information indicating that no removable node N exists in the directed acyclic graph 34A. For example, as shown in FIG. 24, the display controller 56 performs control of displaying, on the display 23, the directed acyclic graph 34A and a message indicating that no removable node N exists.

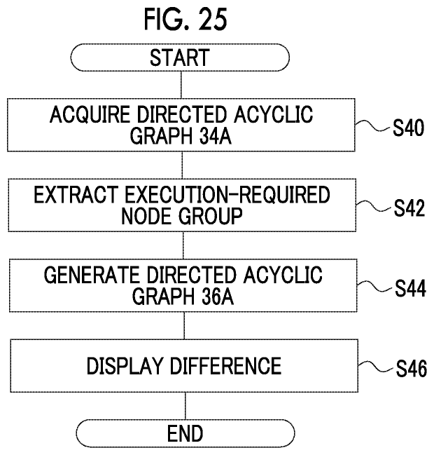

Next, an operation of the information processing apparatus 10 according to the second embodiment will be described with reference to FIG. 25. The CPU 20 executes the information processing program 30 to execute node removal processing shown in FIG. 25. The node removal processing is executed, for example, in a case where an instruction to start the execution is input by the user.

In step S40 of FIG. 25, the acquisition unit 50 acquires the directed acyclic graph 34A from the storage unit 22. In step S42, as described above, the extraction unit 52 extracts the execution-required node group including the nodes N satisfying the condition corresponding to the execution priority of the work, from the directed acyclic graph 34A acquired in step S40.

In step S44, as described above, the generation unit 54 generates the directed acyclic graph 36A in which the node group other than the execution-required node group is removed from the directed acyclic graph 34A based on the execution-required node group extracted in step S42. In step S46, as described above, the display controller 56 performs control of displaying the difference between the directed acyclic graph 34A and the directed acyclic graph 36A in an identifiable display mode. In a case where the processing of step S46 is ended, the node removal processing is ended.

The CPU 20 executes processing for solving the optimization problem using the directed acyclic graph 36A generated as described above. Specifically, the CPU 20 obtains a solution in which the output of the objective function is minimized by performing search processing on the directed acyclic graph 36A by using a known search algorithm such as a breadth-first search.

As described above, according to the second embodiment, it is possible to reduce the computational complexity in a case of obtaining the solution of the optimization problem by using the directed graph.

The disclosed technology may be applied to an optimization problem that can be expressed by a directed acyclic graph having a structure different from the directed acyclic graph 34A in the example shown in the second embodiment. In addition, in the second embodiment, the yield may not be 1. In addition, in the second embodiment, for example, the unit of quantity may change before and after the work, such as where one item of a product type is cut in a previous work and becomes ten items in a subsequent work. In addition, in the second embodiment, the work order may be different for each product type.

The first embodiment and the second embodiment may be combined. For example, the node removal processing of the second embodiment may be executed on the directed acyclic graph 36 obtained by the node aggregation processing of the first embodiment. As a result, a third directed acyclic graph in which the node group other than the execution-required node group is removed from the directed acyclic graph 36 is obtained. That is, the CPU 20 may extract the execution-required node group including nodes satisfying the condition corresponding to the execution priority of the work, from the directed acyclic graph 36. In this case, the CPU 20 may further generate the third directed acyclic graph in which the node group other than the execution-required node group is removed from the directed acyclic graph 36 based on the extracted execution-required node group.

In addition, for example, the node aggregation processing of the first embodiment may be executed on the directed acyclic graph 36A obtained by the node removal processing of the second embodiment. As a result, a third directed acyclic graph is obtained in which the aggregatable subgraph in the directed acyclic graph 36A is replaced with a node obtained by aggregating the subgraph. That is, the CPU 20 may extract, from the directed acyclic graph 36A, a subgraph that is aggregatable without adding variables defining the work information and constraint conditions constituting the optimization problem and that includes at least one edge and two or more nodes connected by the edge. In this case, the CPU 20 may further generate the third directed acyclic graph in which the subgraph in the directed acyclic graph 36A is replaced with a node obtained by aggregating the subgraph.

In each of the embodiments described above, for example, as a hardware structure of a processing unit that executes various types of processing such as each functional unit of the information processing apparatus 10, various processors shown below can be used. As described above, in addition to the CPU that is a general-purpose processor that executes software (program) to function as various processing units, the various processors include a programmable logic device (PLD) that is a processor whose circuit configuration can be changed after manufacture, such as a field programmable gate array (FPGA), and a dedicated electric circuit that is a processor having a circuit configuration that is designed for exclusive use in order to execute a specific process, such as an application specific integrated circuit (ASIC).

One processing unit may be configured by one of the various processors, or may be configured by a combination of the same or different types of two or more processors (for example, a combination of a plurality of FPGAs or a combination of the CPU and the FPGA). Alternatively, a plurality of processing units may be composed of one processor.

As an example of configuring the plurality of processing units with one processor, first, there is a form in which one processor is configured by a combination of one or more CPUs and software and the processor functions as the plurality of processing units, as represented by computers such as a client and a server. Second, as typified by a system on chip (SoC) or the like, there is a form in which a processor that implements functions of the entire system including the plurality of processing units on one integrated circuit (IC) chip is used. As described above, as a hardware structure, various types of processing units are configured by using one or more of the various processors.

Furthermore, as the hardware structure of the various processors, more specifically, an electric circuit (circuitry) in which circuit elements such as semiconductor elements are combined can be used.

In each embodiment described above, the aspect has been described in which the information processing program 30 is stored (installed) in the storage unit 22 in advance, but the present disclosure is not limited to this. The information processing program 30 may be provided in a form of being recorded on a recording medium such as a compact disc read only memory (CD-ROM), a digital versatile disc read only memory (DVD-ROM), and a Universal Serial Bus (USB) memory. A form may be employed in which the information processing program 30 may be downloaded from an external device via a network.

The disclosure of JP2023-209554 filed on Dec. 12, 2023, is incorporated by reference in its entirety into the present specification. In addition, all documents, patent applications, and technical standards described in the present specification are incorporated in the present specification by reference to the same extent as in a case where individual documents, patent applications, and technical standards are specifically and individually indicated to be incorporated by reference.

What is claimed is:

1. An information processing apparatus comprising:
at least one processor,
the processor being configured to:
acquire a first directed acyclic graph in which element information related to an element constituting an optimization problem to be solved corresponds to a node and an order relationship between the elements corresponds to an edge;
extract an execution-required node group including nodes satisfying a condition corresponding to an execution priority of the element, from the first directed acyclic graph; and
generate a second directed acyclic graph in which a node group other than the execution-required node group is removed from the first directed acyclic graph, based on the extracted execution-required node group.

2. The information processing apparatus according to claim 1,
wherein the processor is configured to:
generate the second directed acyclic graph in which the node and the edge that are not related to the execution-required node group are removed from the first directed acyclic graph by filtering the first directed acyclic graph with the execution-required node group.

3. The information processing apparatus according to claim 1,
wherein the element includes work performed by a worker, and
the execution-required node group includes nodes satisfying a condition that an initial inventory of a work object is less than a threshold value.

4. The information processing apparatus according to claim 1,
wherein the element includes work performed by a worker, and
the execution-required node group includes nodes satisfying a condition that the work is required to be performed at a specific time period.

5. The information processing apparatus according to claim 1,
wherein the element includes work performed by a worker, and
the execution-required node group includes nodes satisfying a condition that the work is required to be performed within a predetermined period after completion of a previous work.

6. The information processing apparatus according to claim 1,
wherein the element includes work performed by a worker, and
the execution-required node group includes nodes satisfying a condition that the work is work on a work object for which a delivery date is set.

7. The information processing apparatus according to claim 1,
wherein the processor is configured to perform control of displaying a difference between the first directed acyclic graph and the second directed acyclic graph in a display mode in which the difference is identifiable.

8. The information processing apparatus according to claim 1,
wherein the processor is configured to:
perform control of displaying the first directed acyclic graph and information indicating that no removable node exists in the first directed acyclic graph in a case where a node group constituting the first directed acyclic graph and the execution-required node group match each other.

9. The information processing apparatus according to claim 1,
wherein the processor is configured to:
extract, from the generated second directed acyclic graph, a subgraph that is aggregatable without adding variables defining the element information or constraint conditions constituting the optimization problem and that includes at least one edge and two or more nodes connected by the edge; and
generate a third directed acyclic graph in which the subgraph in the second directed acyclic graph is replaced with a node obtained by aggregating the subgraph.

10. An information processing method executed by a processor provided in an information processing apparatus, the method comprising:
acquiring a first directed acyclic graph in which element information related to an element constituting an optimization problem to be solved corresponds to a node and an order relationship between the elements corresponds to an edge;
extracting an execution-required node group including nodes satisfying a condition corresponding to an execution priority of the element, from the first directed acyclic graph; and
generating a second directed acyclic graph in which a node group other than the execution-required node group is removed from the first directed acyclic graph, based on the extracted execution-required node group.

11. A non-transitory computer-readable storage medium storing an information processing program causing a processor provided in an information processing apparatus to execute a process comprising:
acquiring a first directed acyclic graph in which element information related to an element constituting an optimization problem to be solved corresponds to a node and an order relationship between the elements corresponds to an edge;
extracting an execution-required node group including nodes satisfying a condition corresponding to an execution priority of the element, from the first directed acyclic graph; and
generating a second directed acyclic graph in which a node group other than the execution-required node group is removed from the first directed acyclic graph, based on the extracted execution-required node group.
